(19) United States
(12) Patent Application Publication
(10) Pub. No.: US 2014/0287342 A1
(43) Pub. Date: Sep. 25, 2014

(54) HIGH PERFORMANCE FUEL ELECTRODE FOR A SOLID OXIDE ELECTROCHEMICAL CELL

(71) Applicant: TECHNICAL UNIVERSITY OF DENMARK, Kgs. Lyngby (DK)

(72) Inventors: Mohammed Hussain Abdul Jabbar, Chennai (IN); Jens Høgh, Frederiksberg C (DK); Nikolaos Bonanos, Roskilde (DK)

(73) Assignee: Technical University of Denmark, Kgs. Lyngby (DK)

(21) Appl. No.: 14/353,648

(22) PCT Filed: Oct. 23, 2012
(86) PCT No.: PCT/EP2012/070951

§ 371 Date: Apr. 23, 2014

(30) Foreign Application Priority Data
Oct. 24, 2011 (DK) PA 2011 00811

(51) Int. Cl. C25B 11/04; H01M 4/88; H01M 4/86

(52) U.S. Cl. CPC C25B 11/0484; H01M 4/8657; H01M 4/8846
USPC 429/482; 204/290.12; 205/334; 427/115

(57) ABSTRACT

A high performance anode (fuel electrode) for use in a solid oxide electrochemical cell is obtained by a process comprising the steps of (a) providing a suitably doped, stabilized zirconium oxide electrolyte, such as YSZ, ScYSZ, with an anode side having a coating of electronically conductive perovskite oxides selected from the group consisting of niobium-doped strontium titanate, vanadium-doped strontium titanate, tantalum-doped strontium titanate and mixtures thereof, thereby obtaining a porous anode backbone, (b) sintering the coated electrolyte at a high temperature, such as 1200° C. in a reducing atmosphere, for a sufficient period of time, (c) effecting a precursor infiltration of a mixed catalyst into the backbone, said catalyst comprising a combination of noble metals Pd or Pt or Pd or Ru and Ni with rare earth metals, such as Ce or Gd, said infiltration consisting of (1) infiltration of Pd, Ru and CGO containing chloride/nitrate precursors and (2) infiltration of Ni and CGO containing nitrate precursors, and (d) subjecting the resulting structure of step (c) to heat treatments, including heat treatments in several steps with infiltration.

The present invention relates to a high performance anode (fuel electrode) for use in a solid oxide electrochemical cell. More specifically, the invention concerns the preparation of a novel anode structure by dual infiltration, where the electrocatalytic activity of the Ni-containing electrode has been increased by adding small quantities of single noble metals or mixtures thereof. The invention is applied in particular to provide a low temperature solid oxide fuel cell (SOFC) anode.

A solid oxide fuel cell (SOFC) is an electrochemical cell with an anode (fuel electrode) and a cathode separated by a dense oxide ion conductive electrolyte, said cell operating at high temperatures (800-1000° C.). These conventional high temperatures lead to electrode problems, such as densification and fast degradation of the electrode materials being employed and hence, increased resistance in the electrode/electrolyte interface. These problems are less pronounced at intermediate temperature (600-850° C.) operation. Further lowering the operating temperature of such cells (≦600° C.) may enable the possibility of a wider material selection with relatively fewer of the problems encountered in high temperature operation. In spite of this advantage, lowering the operation temperature leads to increasing interfacial resistance between the electrode and the electrolyte. A low temperature operation also imposes serious challenges to the electrode performance for the hydrogen oxidation. An approach to overcome this challenge is by precursor infiltration of a specific, properly chosen electrocatalyst with sufficient loadings.

The anode of an SOFC comprises a catalytically active, conductive (for electrons and oxide ions) porous structure, which is deposited on the electrolyte. The function of an SOFC anode is to react electrochemically with the fuel, such as hydrogen or hydrocarbons, while the cathode function is to react with oxygen (or air) and produce electric current. The conventional SOFC anodes include a composite mixture of a metallic catalyst and a ceramic material, more specifically nickel and yttria-stabilized zirconium oxide (YSZ), respectively. However, the interfacial resistance of the nickel-based composite anode is still too high for SOFCs to be operated in low temperature ranges.

Over the recent years a number of efforts have been made to improve the functioning of SOFC anodes. For instance, U.S. Pat. No. 6,051,329 describes an SOFC with a porous ceramic anode comprising a noble metal catalyst chosen from Pt, Rh, Ru and mixtures thereof. The ceramic material in the anode may for example be YSZ; there was no specific mentioning of niobium-doped strontium titanates, but perovskite materials in general are mentioned.

US 2005/0120827 mentions that catalyst alloys, i.a. alloys of Ni, Ni—Pd and Ni—Pt, can be used as anodes in SOFCs.

Furthermore, US 2009/0305090 concerns catalyst compositions for fuel cell use, and according to the publication the catalyst of the anode can be Ce-oxide, Ce—Zr-oxide, Ce—Y-oxide, Cu, Ag, Au, Ni, Mn, Mo, Cr, V, Fe, Co, Ru, Rh, Pd, Pt, Ir, Os, a perovskite or any combinations thereof.

US 2010/0151296 describes an electrode catalyst for fuel cell use, more specifically a non-platinum catalyst (Mn, Pd, Ir, Au, Cu, Co, Ni, Fe, Ru, WC, W, Mo, Se) together with a Ce-catalyst, which can be metallic Ce or Ce-oxide. The electrode catalyst had improved catalytic efficiency because of the presence of Ce.

US 2011/0003235 describes an SOFC with a porous anode interlayer with nano-structure, that can consist of a mixture of nano-Ni and nano-Y stabilized zirconia (YSZ/Ni) or a mixture of nano-Ni and nano-Gd doped ceria (GDC/Ni).

JP2007-149431 concerns an SOFC with an interlayer consisting of a Ce-oxide coated electrolyte, where the coating has been applied by screen printing. After formation of a Ce-oxide sintering layer a Ni-containing metal precursor was impregnated into the layer.

US 2002/0187389 discloses a high performance electro catalyst based on transition metal perovskites of Pr, Sm, Tb or Nd, which reacts with YSZ and forms a product that is actine as fuel cell cathode in itself. An SOFC with a cathode consisting solely of the reaction product between YSZ and PrCoO3 displays a good performance, indicating that this phase in itself not only was a good conductor, but also a good catalyst for oxygen activation.

Finally, Applicant's own publication US 2009/0061284 mentions that i.a. niobium-doped strontium titanate can be used as SOFC anode, said anode being impregnated with a metal (such as Ni) and doped cerium oxide. However, no mention is made of using noble metal catalysts or “multicatalysts” in order to obtain a possible synergistic effect.

The most commonly studied anodes for low temperature SOFCs are based on a Ni-electrocatalyst and an oxide ionic conductor, e.g. selected from Ni-CGO (gadolinium-doped ceria) cermets. The parameters influencing the performance of the Ni-CGO anodes are grain size, porosity, Ni/CGO ratio and the CGO stoichiometry. Specific Ni-CGO anodes deposited by spray pyrolysis on YSZ electrolytes have shown a polarization resistance (Rₚ) of 7.2Ωcm² at 600° C. and 61.5Ωcm² at 400° C. in moisturized H₂ fuel (U. P. Muecke et al., Electrochemical performance of nanocrystalline nickel/gadolinia-doped ceria thin film anodes for solid oxide fuel cells, Solid State Ionics 178 (33-34), p. 1762-1768 (2008)). The electrochemical performance of the anode can be further enhanced by electrocatalyst precursor infiltration on the porous anodes using precursor infiltration techniques. A polarization resistance of 1.66Ωcm² at 650° C. in moisturized H₂ fuel can be obtained by infiltration of Pd in the Ni-CGO backbone (A. Babaei et al., Electrocatalytic promotion of palladium nanoparticles for hydrogen oxidation on Ni-CGO anodes of SOFCs via spillover, J. Electrochem. Soc. 156 (9) B 1022-1029 (2009)). Moreover, a perovskite such as Nb-doped SrTiO₃ (STN) infiltrated with Ni-ceria showed an improved electrochemical performance, compared to perovskite only, at intermediate temperatures, and further, Nb-doped SrTiO₃ possesses a stable backbone under anodic conditions to hold the infiltrated catalyst with adequate electronic conductivity at low temperatures (P. Blennow et al., Defect and electrical transport properties of Nb-doped SrTiO₃, Solid State Ionics 179 (35-36), p. 2047-2058 (2008)).

Thus, the recent developments within high performance SOFC anodes have been focused on utilizing the electronically conductive perovskite oxides, such as niobium-doped strontium titanate (STN). While STN is stable under anode testing conditions and also compatible with the electrolyte, it lacks electrochemical catalytic activity for the hydrogen oxidation, and moreover the ionic conductivity is insufficient to extend to the possible sites of oxidation.

STN deposited on the electrolyte has a skeletal porous structure (termed “backbone” in the following), which is capable of holding the electrocatalyst. One of the recent trends within the development of anodes has been to incorporate a nanostructured electrocatalyst in the backbone by catalyst infiltration of the respective salts, such as nickel nitrate or nickel chloride. The electrocatalyst can be a metal, a ceramic material such as gadolinium-doped cerium oxide (CGO) or a mixture of both. In addition to catalytic activity CGO provides oxide ion conductivity in the STN backbone.

At present, STN is the preferred backbone material according to the invention, but other materials may be useful as well. Among these other materials, especially FeCr-3YSZ should be mentioned. Anodes with very high performance may thus be produced by infiltration of a multicatalyst into a backbone consisting of FeCr-3YSZ.

The present invention is based on dual infiltration of precursors of a mixed electrocatalyst in the backbone, preferably an STN backbone, comprising a combination of noble metals (Pd, Ru and Pt) and Ni with CGO. The synergistic effect of the combined electrocatalyst provides for an improved electrochemical reaction in connection with hydrogen oxidation in the STN backbone. The interfacial resistance of the STN backbone incorporated with the mixed catalyst is low compared to CGO, Ni-CGO, Pd-CGO and Ru-CGO as electrocatalyst.

More specifically the present invention relates to a high performance anode (fuel electrode) for use in a solid oxide electrochemical cell, said anode being obtainable by a process comprising the steps of (a) providing a suitably doped, stabilized zirconium oxide electrolyte, such as YSZ, ScYSZ, with an anode side having a coating of electronically conductive perovskite oxides selected from the group consisting of niobium-doped strontium titanate, vanadium-doped strontium titanate, tantalum-doped strontium titanate and mixtures thereof, thereby obtaining a porous anode backbone, (b) sintering the coated electrolyte at a high temperature, such as 1200° C. in a reducing atmosphere, for a sufficient period of time, (c) effecting a precursor infiltration of a mixed catalyst into the backbone, said catalyst comprising a combination of noble metals Pd or Pt or Pd or Ru and Ni with rare earth metals, such as Ce or Gd, said infiltration consisting of (1) infiltration of Pd, Ru and CGO containing chloride precursors and (2) infiltration of Ni and CGO containing nitrate precursors, and (d) subjecting the resulting structure of step (c) to calcinations, including calcinations in several steps with infiltration.

It is novel over the existing technology that the electrocatalytic activity of Ni-containing catalysts can be improved by adding a small quantity of a noble metal or mixtures of such metals. The very idea of utilizing the electrocatalytic activity of noble metal catalysts alone or in combination with similar noble metal catalysts, with nickel, with a ceramic electrocatalyst (CGO) or combinations thereof in order to obtain a greater synergistic electrocatalytic activity in a perovskite oxide STN backbone is also novel. The invention in particular finds use for low temperature SOFC anodes, but it is also useful in high temperature operating SOFCs and SOECs (600 to 850° C.)

The infiltration of Pd and Ru mixtures or Pt or Pd or Ru and CGO containing chloride/nitrate precursors is preferably followed by a first calcination prior to infiltration of Ni and CGO containing nitrate precursors.

The present invention also relates to a specific anode structure, wherein the infiltrations in the above step (c) are obtained by a process comprising the steps of (1) first infiltrating the STN backbone with Pd-CGO or Pt-CGO or Ru-CGO binary electrocatalyst followed by Ni-CGO binary electrocatalysts to obtain a ternary electrocatalyst combination or (2) first infiltrating the STN backbone with Pd—Ru-CGO ternary electrocatalyst catalyst followed by Ni-CGO binary electrocatalysts to obtain a quaternary electrocatalyst combination.

In the anode structure according to the invention the electrolyte preferably is a tape with a thickness of about 120 μm. Furthermore it is preferred that the heat treatment step (d) is carried out for about 2 hours at a temperature of approximately 650° C. in air and that the heat treatment step (f) is carried out for about 1 hour at a temperature of approximately 350° C. in air.

The anode structure according to the invention is preferably used in a solid oxide fuel cell (SOFC), but it may also be used in a solid oxide electrolyser cell (SOEC).

In solid oxide cells the interfacial resistance of the electrodes is quite high at low temperatures. With the present invention it has become possible to reduce the inter-facial resistance of the anode in the low temperature range significantly by utilizing the synergistic effect of noble metal catalysts in combination with Ni and CGO.

Conventionally the low temperature SOFC anodes are prepared as composite mixtures of catalyst (Ni) and oxide ion conductor (YSZ). The present invention has made it possible to replace such anodes with highly conductive perovskite-type oxides impregnated with noble metal catalysts in combination with Ni and CGO. Among the advantages over the prior art SOFC anodes the low interfacial resistance of the inventive SOFC anodes operating in the low temperature range has already been mentioned. Another substantial advantage is that the electrochemical activity of the Ni-CGO electrocatalyst is increased by addition of a minor quantity of noble metals as additive.

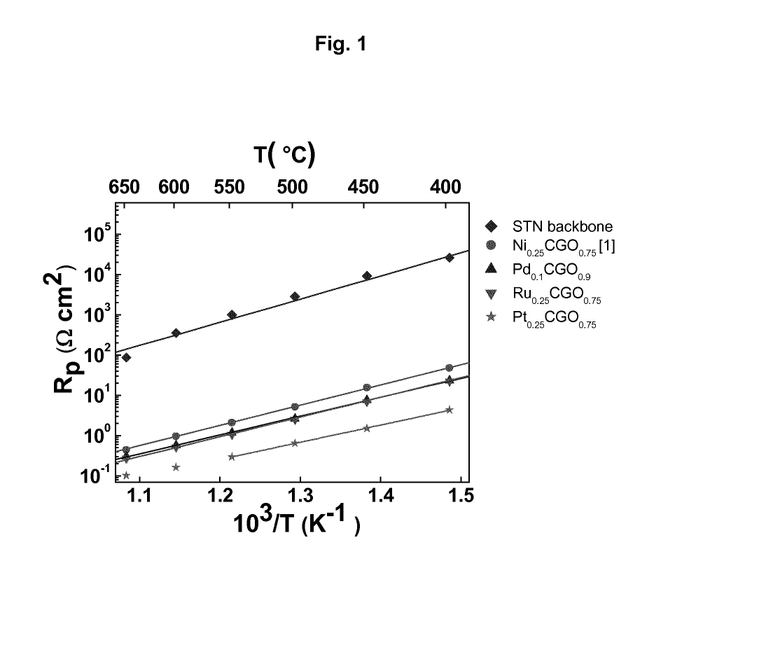

The invention will now be illustrated further by the following specific examples. Reference is also made to the accompanying FIGS. 1-7, where

FIG. 1 shows an Arrhenius plot illustrating the performance of the STN backbone without infiltration and with infiltrations such as Ni-CGO, Pd-CGO, Ru-CGO and Pt-CGO. A considerable enhancement in performance was achieved with infiltration compared to STN without infiltrations;

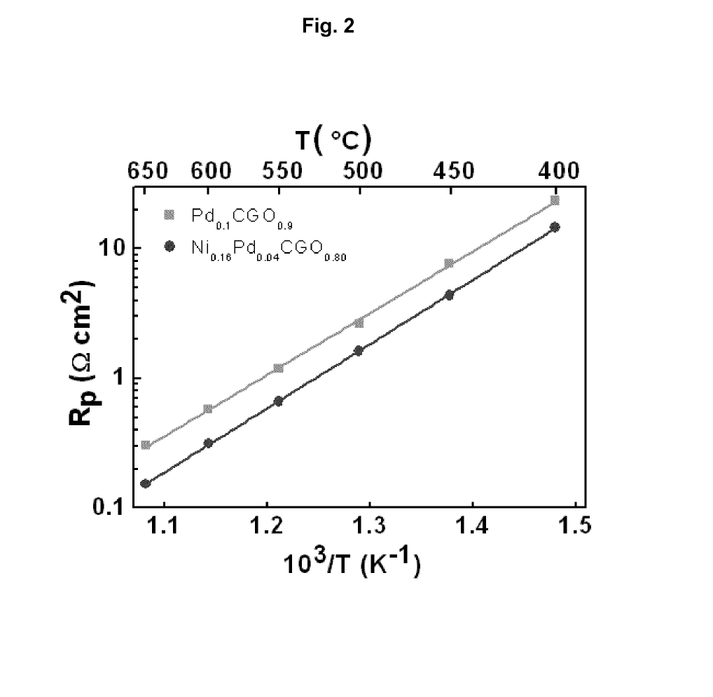

FIG. 2 shows an Arrhenius plot illustrating the improvement in performance of Ni-CGO with the addition of Pd and compared with only Pd-CGO electrocatalyst;

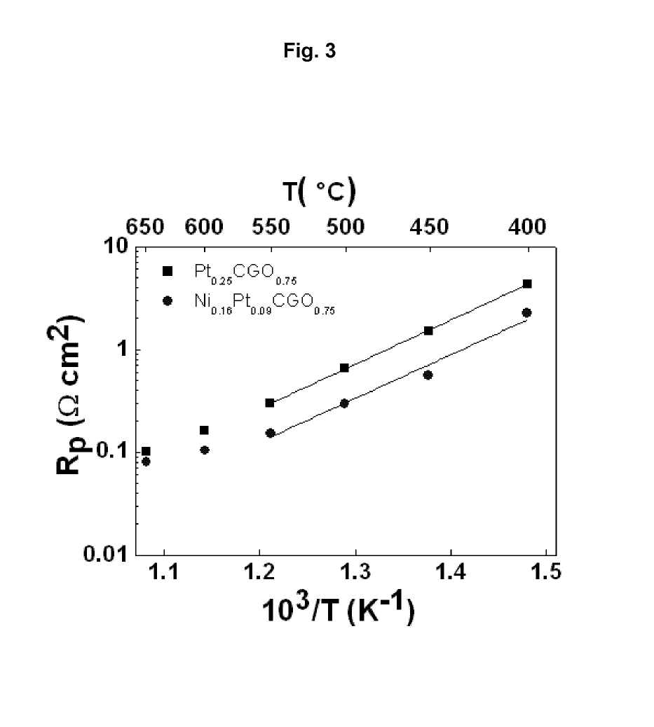

FIG. 3 shows an Arrhenius plot illustrating the improvement in performance of Ni-CGO with the addition of Pt and compared with only Pt-CGO electrocatalyst;

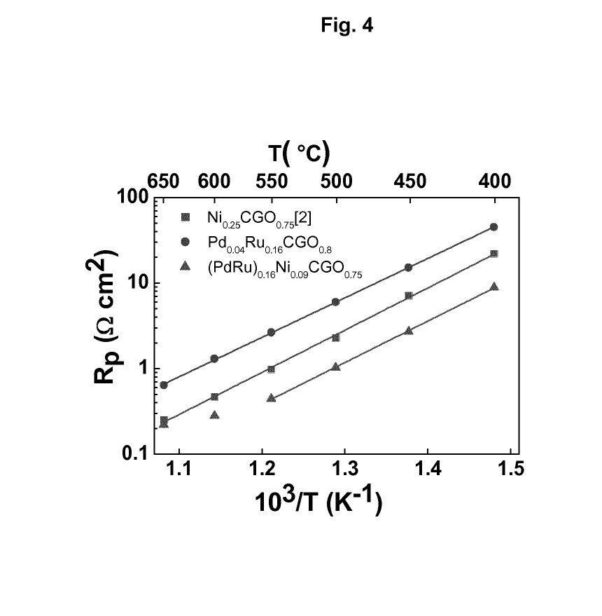

FIG. 4 shows an Arrhenius plot illustrating the synergetic performance of Ru—Pd—Ni-CGO electrocatalyst and compared with the performance of Ni-CGO and Ru—Pd-CGO. Note: the multicatalyst performance is shown in the STN backbone;

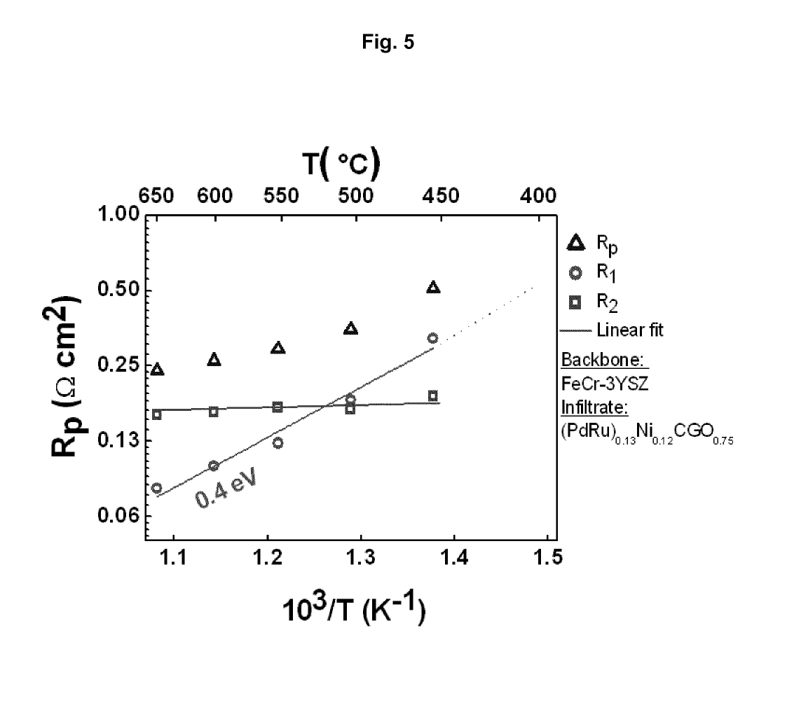

FIG. 5 shows an Arrhenius plot illustrating the performance of Ru—Pd—Ni-CGO electrocatalyst in a backbone (FeCr-3YSZ) different from STN. Rₚ is the total resistance (R₁+R₂), where R₁ is the electrode process resistance and R₂ indicates diffusion resistances;

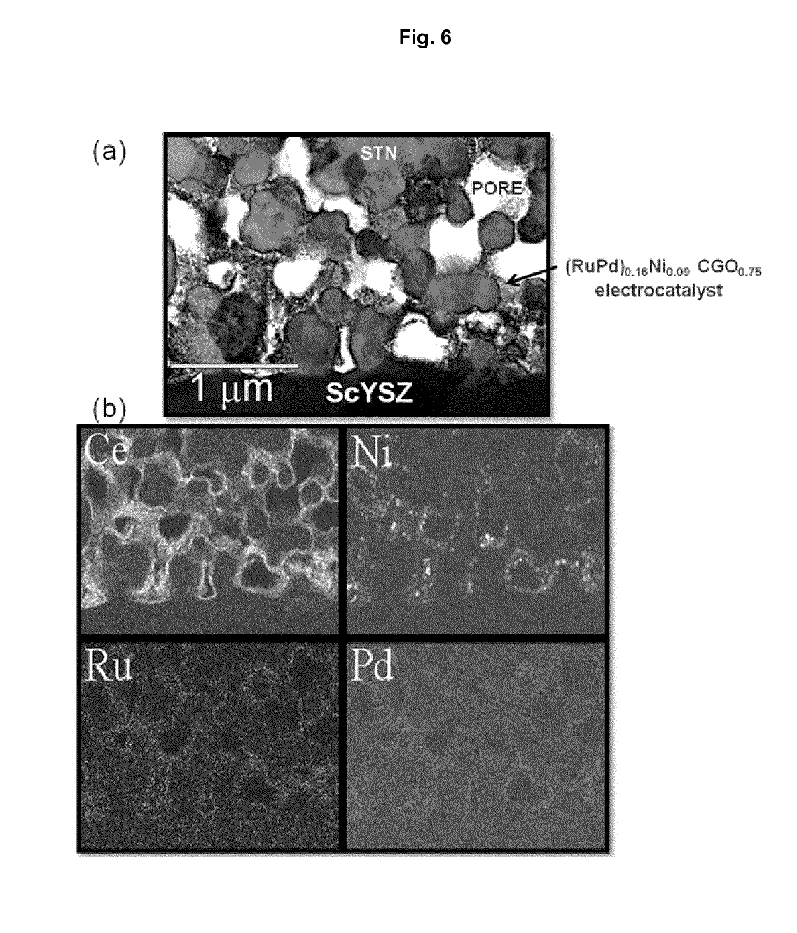

FIG. 6 depicts the transmission electron microscopy (TEM) micrograph showing a well defined STN backbone with pores and the infiltrated multicatalyst covering the STN homogeneously (a) and the individual elemental mapping of Ce, Ni, Ru and Pd (b), and

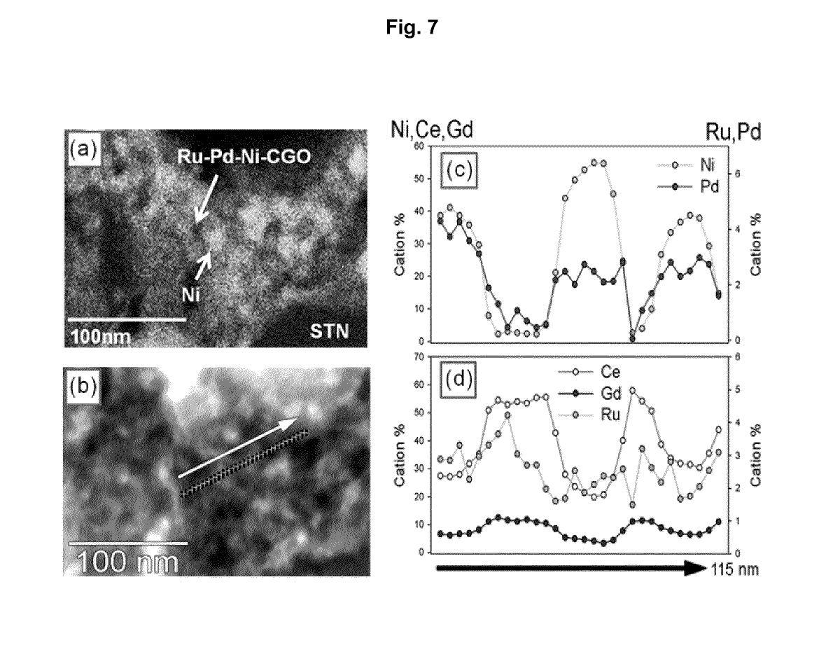

FIG. 7 depicts scanning transmission electron microscopy (STEM) images with energy dispersive spectroscopy (EDS) mapping of Ru—Pd—Ni-CGO multicatalyst (a), line scanning microanalysis (b) and STEM-EDS results of Ru—Pd—Ni-CGO electrocatalyst (c-d).

The examples describe the electrochemical characterization of porous symmetrical Sr_{0.94}Ti_{0.9}Nb_{0.1}O_{3-δ} (STN) cells infiltrated with Pt, Ru, Pd, Ni and CGO or combinations thereof at low working temperature.

The performance of the STN anodes infiltrated with Ni-CGO, Pd-CGO, Pt-CGO and Pd—Ru-CGO have been compared with Ni containing catalyst Pd—Ni-CGO, Pt—Ni-CGO and Ru—Pd—Ni-CGO electrocatalyst, respectively. STN anodes without any infiltrations were also compared with the infiltrated anodes. The improved performance of an infiltrated precursor possibly depends on the catalytic activity of the respective electrocatalyst, the synergistic effect of mixed catalysts and the resulting morphology of the electrocatalysts after the calcinations steps.

### EXAMPLE 1

### STN Powder Preparation

This example illustrates the preparation of powdery STN. The STN perovskite oxide was prepared using a wet chemical route known per se. Stoichiometric amounts of strontium carbonate (SrCO₃), niobium oxalate (C₂NbO₄) and titanium(IV)isopropoxide (Ti[OCH(CH₃)₂]₄) were used to obtain Sr_{0.94}Ti_{0.9}Nb_{0.1}O₃. The compounds Ti[OCH(CH₃)₂]₄ and C₂NbO₄ were dissolved separately in citric acid monohydrate (HOC(COOH) (CH₂COOH)₂.H₂O) and the precursors were mixed. Subsequently SrCO₃ powder was added slowly with hydrogen peroxide (H₂O₂) as accelerator for the decomposition of SrCO₃. The mixtures were heated on a hot plate at 300° C. for 5 hours. Then the resulting solids were heat treated at 1000° C. for 3 hours in air and subsequently ground to a fine powder.

### EXAMPLE 2

### Symmetric Cell Preparation for Anode Characterization

Porous STN anodes were deposited on scandia, yttria-stabilized zirconium oxide, 10 mole % Sc₂O₃ in 1 mole % Y₂O₃ stabilized ZrO₂ (ScYSZ) electrolyte tapes by screen printing. STN powders were formulated as a screen printing ink by addition of a surfactant (a polymeric dispersant), a plasticizer (dibutyl phthalate) and a binder (ethyl cellulose) and mixed homogeneously in a mechanical shaker overnight.

Then the screen printed STN on ScYSZ tapes were sintered at 1200° C. for 4 hours in a reducing atmosphere (9% H₂/N₂). The porous STN anodes were deposited on both sides of the ScYSZ electrolyte tapes with an area of 6×6 cm². Each tape was cut into smaller pieces with an approximate area of 0.25 cm² for use in the electrochemical set-up.

A 0.75 M precursor solution of CGO (Ce_{0.8}Gd_{0.2}O_{2-δ}) was prepared by dissolving cerium nitrate (Ce(NO₃)₃.6H₂O) and gadolinium nitrate (Gd(NO₃)₃.6H₂O) in water along with polymeric surfactants. Precursor solutions yielding a composition of Ni_{0.25}CGO_{0.75}, Pd0.1CGO_{0.9}, Ru_{0.25}CGO_{0.75}, Pt0.25CG^{0.75}, Pt_{0.08}Ru_{0.07}CGO_{0.85}, Pt_{0.07}Pd_{0.08}CGO_{0.85}, Ni_{0.16}Pt_{0.09}CGO_{0.75}, Pd_{0.04}Ru_{0.16}CGO_{0.75}, Ni_{0.16}Ru_{0.09}CGO_{0.75} or Ni_{0.16}Pd_{0.04}CGO_{0.75} were prepared by dissolving the metal nitrates/chlorides of the respective metal(s) in CGO precursor. The subscripts mentioned in the above compositions represent the weight percentages of metal(s) and CGO. For Ni, Pt and Pd metals, nickel nitrate (Ni(NO₃)₂.6H₂O), tetraammine platinum(II)nitrate (H₁₂N₆O₆Pt) and palladium nitrate (Pd(NO₃)₂.6H₂O), respectively, was used. In case of the Ru-containing infiltrates, ruthenium chloride (RuCl₃.xH₂O) and palladium chloride (PdCl₂) were used as precursors. The volume percentage of the catalyst mixtures in the STN backbone is indicated in the tables on the following page.

### Backbone I: STN (Reduced)

| | Loading in STN (vol %) | | | | | | Rp | Rp | Activ. |
|---|---|---|---|---|---|---|---|---|---|
| | | | | Met. 1 + | Met. 2 + | | (Ω · cm²) | (Ω · cm²) | energy |
| Inf. | Metal 1 | Metal 2 | CGO | CGO | CGO | total | 600° C. | 500° C. | (eV) |
| A | 3.17 | NA | 9.50 | 12.66 | NA | 12.66 | 0.96 | 5.13 | 1.09 |
| B | 6.17 | NA | 18.50 | 24.66 | NA | 24.66 | 0.4 | 2.28 | 0.99 |
| C | 1.91 | NA | 5.72 | 7.63 | NA | 7.63 | 0.16 | 0.64 | 0.84 |
| D | 1.30 | NA | 10.56 | 11.86 | NA | 11.86 | 0.57 | 2.62 | 0.93 |
| E | 4.52 | NA | 13.57 | 18.09 | NA | 18.09 | 0.51 | 2.5 | 0.97 |
| F | 0.60 | 2.62 | 12.72 | 5.47 | 10.47 | 16.00 | 1.3 | 5.95 | 0.91 |
| G | 0.79 | 0.86 | 9.35 | 3.15 | 7.84 | 11.00 | 0.16 | 0.52 | 0.89 |
| H | 1.27 | 1.16 | 13.16 | 5.07 | 10.52 | 15.59 | 0.09 | 0.26 | 0.83 |

### Ni-Containing Mixed Catalysts

| | Loading (vol %) | | | | | | Rp | Rp | Activ. |
|---|---|---|---|---|---|---|---|---|---|
| | | | | Met. 1 + | Met. 2 + | | (Ω · cm²) | (Ω · cm²) | energy |
| Inf. | Metal 1 | Metal 2 | CGO | CGO | CGO | total | 600° C. | 500° C. | (eV) |
| J | 1.14 | 2.16 | 9.90 | 4.56 | 8.64 | 13.20 | 0.1 | 0.3 | 0.85 |
| K | 0.62 | 2.15 | 11.49 | 5.67 | 8.59 | 14.26 | 0.31 | 1.62 | 0.98 |
| L | 1.28 | 2.27 | 10.65 | 5.12 | 9.08 | 14.20 | 0.82 | 4.35 | 0.93 |
| M | 3.90 | 2.06 | 17.86 | 15.59 | 8.22 | 23.81 | 0.28 | 1.02 | 0.96 |

### Backbone II: FeCr-3YSZ

| | Loading (vol %) | | | | | | Rp | Rp | Activ. |
|---|---|---|---|---|---|---|---|---|---|
| | | | | Met. 1 + | Met. 2 + | | (Ω · cm²) | (Ω · cm²) | energy |
| Inf. | Metal 1 | Metal 2 | CGO | CGO | CGO | total | 600° C. | 500° C. | (eV) |
| N | 4.02 | 3.57 | 22.78 | 16.08 | 14.29 | 30.37 | 0.26 | 0.35 | 0.40 |

In the above table, the infiltrates (Inf.) are as follows:
A: Ni_{0.25}CGO_{0.75}[1]
B: Ni_{0.25}CGO_{0.75}[2]
C: Pt_{0.25}CGO_{0.75}
D: Pd_{0.1}CGO_{0.9}
E: Ru_{0.25}CGO_{0.75}
F: Pd_{0.04}Ru_{0.16}CGO_{0.75}
G: Pt_{0.07}Pd_{0.08}CGO_{0.85}
H: Pt_{0.08}Ru_{0.07}CGO_{0.85}
J: Ni_{0.16}Pt_{0.09}CGO_{0.75}
K: Ni_{0.16}Pd_{0.04}CGO_{0.75}
L: Ni_{0.16}Ru_{0.09}CGO_{0.75}
M: (RuPd)_{0.16}Ni_{0.09}CGO_{0.75}
N: (RuPd)_{0.13}Ni_{0.12}CGO_{0.75}

Note: The subscripts mentioned in A-N represent the weight percentages of metal(s) and CGO.

The table illustrates the weight percentage of metal (Ni) and ceramic (CGO) loading in the backbone. The column “total” indicates the total amount of catalyst including Ni-CGO. Also the performance, expressed in terms of activation energy at 500 and 600° C. in H₂/3% H₂O, is indicated.

The infiltrated STN anodes were prepared by dropping the precursors into the porous STN symmetrical cells, and then the cells were placed in a vacuum chamber. A vacuum was applied to remove the air bubbles from the porous STN backbone and to facilitate the solution precursors to homogeneously coat the surface of the anode with the capillary forces. Ni-CGO, Pd-CGO, Pt-CGO and Ru-CGO were infiltrated 3 times to increase the loadings in the porous STN, and after each infiltration the cells were calcined at 350° C. for 1 hour. Ru—Pd—Ni-CGO infiltrations were done by infiltrating once with the Ru—Pd-CGO mixed precursor followed by calcination at 650° C. for 2 hours in order to remove the chloride residues. Afterwards the symmetrical cells were infiltrated 3 times with Ni-CGO by using the procedure mentioned above. A similar procedure was followed for Ni—Pt-CGO, Ni—Pd-CGO and Ni—Ru-CGO electrocatalysts, wherein Pt-CGO, Pd-CGO and Ru-CGO was infiltrated first and followed by 3 times of Ni-CGO infiltrations. The change in weight after the calcinations was recorded after each infiltration.

### EXAMPLE 3

### Anode Characterization

The symmetrical cells were electrically contacted using Pt-paste and a Pt-grid. The cells were heated to 650° C. in 9% H₂/N₂, whereafter the gas composition was changed to dry H₂ and the temperature was kept at 650° C. for 12 hours. The EIS data were recorded at open circuit conditions (OCV) by applying an amplitude of 50 mV (the output voltage of the Solartron frequency response analyzer varies from 5 to 50 mV depending on the temperature) in the frequency range of 1 MHz-1 mHz. The impedance was measured in the temperature range from 650 to 350° C. in H₂ with 3% H₂O. The gas compositions were made by humidifying the H₂ in water at room temperature. The partial pressure of oxygen (pO₂) was measured using an oxygen sensor. The EMF values were −1.125, −1.131, −1.140 and −1.147 V and the corresponding pO₂ was 10⁻²⁶, 10⁻²⁷, 10⁻²⁹ and 10⁻³¹ at 650, 600, 550 and 500° C., respectively. The percentage of H₂ was calculated to be approximately 97% with 3% water vapour.

STN without infiltration has Rₚ values that are several orders of magnitude higher. Table 1 lists the activation energy of the anodes being examined. The activation energy of only STN as anode is 1.14 eV as shown. The activation energies of infiltrated anodes lowered slightly compared to STN backbone without infiltration.

FIG. 6 depicts the microstructure of STN anodes infiltrated with Ru—Pd—Ni-CGO. A well defined STN backbone with pores and the infiltrated electrocatalyst covering the STN homogeneously is shown in FIG. 6(a). The elements presented in the microstructure were mapped using TEM-EDS.

The individual elemental mapping of Ce, Ni, Ru and Pd is depicted in FIG. 6(b) corresponding to the microstructure in FIG. 6 (a). The quantity of Ni, Pd and Ru infiltrated in the structure is low and thus the x-ray signals detected were weak, however the major composition of the electrocatalyst is CGO. Ce being a heavier element shows clear x-ray mappings illustrating a uniform coating of STN backbone.

Shown in FIG. 7 are the STEM images with EDS mapping. The maximum operating temperature of the anodes was 650° C. and the size of the Ni electrocatalyst determined by TEM was around 10-15 nm. Other elements (Ru, Pd and Ce) in the nanocomposites are less than 10 nm as depicted in FIG. 7(a). Line scanning microanalysis was done across the nanocomposite marked with an arrow as shown in FIG. 7(b) for a distance of 115 nm. Ni appears to have formed an alloy with Pd as illustrated in FIG. 7(c) and this could have enhanced the electrochemical activity compared to only Ni at low temperature. FIG. 7(d) shows concentrations of Ce and Gd in the microstructure, and Ru and Pd are in low concentration. It is seen from the analysis that the mixed nanocomposites of Ce and Ru cover the places that are less covered by Ni and Pd and because of this they are catalytically active throughout the anode area. Ni—Pd, Ru with CGO facilitates electrochemical oxidation of H₂. In addition, CGO nanoparticles help in promoting oxygen ions. Thus the three phase boundary is enhanced for more electrochemical active sites.

1. A high performance anode (fuel electrode) for use in a solid oxide electrochemical cell, said anode being obtainable by a process comprising the steps of:
(a) providing a doped, stabilized zirconium oxide electrolyte with an anode side having a coating of electronically conductive perovskite oxides selected from the group consisting of niobium-doped strontium titanate (STN), vanadium-doped STN, tantalum-doped STN and mixtures thereof, thereby obtaining a porous anode backbone,
(b) sintering the coated electrolyte at a temperature around 1200° C. in air or in a reducing atmosphere,
(c) effecting a precursor infiltration of a mixed catalyst into the backbone, said catalyst comprising a combination of noble metals (Pt and/or Pd and/or Ru) and Ni with rare earth metals, such as Ce or Gd, where the infiltration combinations are binary (Pt-CGO or Pd-CGO or Ru-CGO or Ni-CGO), ternary (Ni—Pt-CGO or Ni—Pd-CGO or Ni—Ru-CGO) or quaternary (Ni—Pd—Ru-CGO) electrocatalysts, and where the precursors for infiltration are in chloride or nitrate forms,
(d) subjecting the resulting structure of step (c) to calcinations in air to form the nanostructured electrocatalyst, including calcinations in several steps with infiltration,
(e) infiltrating Ni and CGO containing precursors (nitrates) into the backbone of the anode, and
(f) heat-treating the twice electrocatalyst-infiltrated electrolyte,
wherein the infiltrations in step (c) are obtained by a process comprising the steps of (1) first infiltrating the STN backbone with Pd-CGO or Pt-CGO or Ru-CGO binary electrocatalyst followed by Ni-CGO binary electrocatalysts to obtain a ternary electrocatalyst combination or (2) first infiltrating the STN backbone with Pd—Ru-CGO ternary electrocatalyst catalyst followed by Ni-CGO binary electrocatalysts to obtain a quaternary electrocatalyst combination.

2. Anode structure according to claim 1, wherein the electrolyte is a tape with a thickness of about 120 μm screen-printed with 20 μm STN backbone.

3. Anode structure according to claim 1, wherein the heat treatment step (d) is carried out at a temperature of about 650° C.

4. Anode structure according to claim 1, wherein the heat treatment step (f) is carried out at a temperature of about 350° C.

5. Anode structure according to claim 1, wherein a multi-catalyst is infiltrated in the FeCr-3YSZ backbone by adopting the steps (c)-(f).

6. Use of the anode structure according to claim 1 in a solid oxide fuel cell (SOFC).

7. Use of the anode structure according to claim 1 in a solid oxide electrolyser cell (SOEC), in which case it is a cathode.

8. Use of the anode structure according to claim 1 in a high temperature (600 to 850° C.) operating SOEC or SOFC.
